(19) United States
(12) Patent Application Publication
(10) Pub. No.: US 2012/0146536 A1
(43) Pub. Date: Jun. 14, 2012

(54) LED LIGHTING SYSTEM

(76) Inventors: Nate Mullen, Escondido, CA (US); John R. Reeves, Temecula, CA (US); Randy Allen Weisser, Escondido, CA (US)

(21) Appl. No.: 12/966,254

(22) Filed: Dec. 13, 2010

(51) Int. Cl. H05B 37/02; H05B 41/24; H05B 41/16

(52) U.S. Cl. 315/251; 315/294

(57) ABSTRACT

An LED lighting system has a constant AC current source, a circuit loop and a plurality of light emitting diodes in the circuit loop. The constant AC current source eliminates the need for integrated circuits and other circuit components that can fail or be damaged in a light fixture, particularly an outdoor, landscape lighting fixture. The LED lighting system preferably contains a current transformer and/or a full wave bridge rectifier to maximize the number of LEDs in a lighting system—and/or a voltage clamping circuit to minimize the chance of run-away voltage.

### BACKGROUND OF THE INVENTION

The present invention relates to the field of LED (light emitting diode) lighting systems. More particularly, the invention relates to LED lighting systems configured to drive LEDs with a constant alternating current (AC) current source

Prior art LED fixtures available today typically operate on low, i.e., 8-12V direct current (DC) or 12V AC, voltage supplies. Typically such LED fixtures include electronic circuits to convert input power to a voltage and current level suitable to drive the associated LEDs. When the fixture is configured to accept AC input power, the fixture can include circuits to convert the AC input power to DC power for driving the LEDs. When the fixture is configured to accept DC input power, the fixture can include circuits to convert the DC input power to a higher or lower DC voltage for driving the LEDs.

As depicted in FIG. 1, the basic LED circuit 20 consists of a DC voltage source 22 powering two components connected in series: a current limiting resistor 24 and an LED 26. Optionally, a switch (not shown) may also be included to open and close the circuit. The LED 26 will have a specified voltage drop at the intended operating current and the resistor 24 is designed to account for the remaining voltage. Ohm's law and Kirchhoff's circuit laws are used to calculate the resistor that is used to attain the correct current flow through the LED. The resistor value is computed by subtracting the LED voltage drop from the supply voltage 22, and then dividing by the desired LED operating current.

Series resistors are a simple way to stabilize the LED current, but energy is wasted in the resistor. A constant current regulator is commonly used for high power LEDs and low drop-out (LDO) constant current regulators allow the total LED string voltage to be a higher percentage of the power supply voltage, resulting in improved efficiency and reduced power use. Switched-mode power supplies are also used in some LED lights, stabilizing light output over a wide range of battery voltages and increasing the useful life of the batteries. Miniature indicator LEDs are normally driven from a low voltage direct current via a current limiting resistor, where currents of 2 mA, 10 mA and 20 mA are common.

As shown in FIGS. 2 and 3, the electronic circuits, i.e., buck 28 or boost 30, have resistors 24, integrated circuits (ICs) 32, inductors 34, diodes 36 and/or transistors/FETs (field effect transistors) 38 to drive the LEDs 26. Buck circuits 28 are used where the incoming voltage is higher than needed to power the LED 26. Boost circuits 30 are used where the incoming voltage is lower than needed to power the LED 26. In such cases, the electronic circuit is included in the LED fixture and can be easily damaged by moisture, such as is present in a landscape lighting environment.

The voltage versus current characteristics of an LED are much like any diode where current is approximately an exponential function of voltage as described by the Shockley diode equation. It is important that the power source gives the right voltage because a small voltage change can result in a large current change. If the supply voltage is below the threshold or on-voltage for the LED, no current will flow and the result is an unlit LED. If the supply voltage is too high the current will go above the maximum rating, heating and potentially destroying the LED. As the LED heats up, its voltage drop decreases further increasing voltage in the loop. Consequently, LEDs can be connected directly to constant-voltage sources only if special care is taken.

Strings of LEDs are normally operated as series LEDs, with the total LED voltage typically adding up to around two-thirds of the supply voltage, with resistor current control for each string. In disposable coin cell powered key-ring type LED lights, the resistance of the cell itself is usually the only current limiting device. LEDs can be purchased with built in series resistors, which can save printed circuit board (PCB) space and are especially useful when building prototypes or populating a PCB in an unintended manner. However, the resistor value is set at the time of manufacture, removing one of the key methods of setting the LED's intensity.

Typical LEDs require about 0.35 A to be powered and an outdoor system is maxed out at about 30-35V. Assuming a 12V power supply and an LED with a 3V voltage drop, one would need to include a resistor to drop 9V before the LED, or a switching IC to achieve the required constant current.

Therefore there is a need for an improved LED lighting system that provides the required constant current to power an LED without the added electronic circuits of existing LED light fixtures.

### SUMMARY OF THE INVENTION

The present invention is directed to multiple methods of supplying a constant AC current source to an LED light fixture without including electronic circuit elements, i.e., resistors, transistors, capacitors and/or integrated circuits, that waste electricity, generate heat or can be damaged by the intrusion of moisture.

An LED lighting system of the present invention comprises a constant AC current source, a circuit loop electrically connected to the constant AC current source, and one or more light emitting diodes electrically connected in the circuit loop. The one or more light emitting diodes may be connected in a series configuration or in an anti-parallel configuration.

The circuit loop consists of electrical wire connecting the constant AC current source directly to the one or more light emitting diodes. The circuit loop may also connect the one or more light emitting diodes to a current transformer, which is electromagnetically coupled to the constant AC current source. The current transformer typically has a ratio of between 20:1 and 200:1, but may be as low as 10:1 and as high as 1000:1. The constant AC current source provides electricity having a frequency of between 50 hertz and 6,000 hertz, preferably about 600 hertz. The circuit loop may also connect the one or more light emitting diodes to a full wave bridge rectifier electrically connected to the current transformer, where the current transformer is electromagnetically coupled to the constant AC current source. In this instance the electrical source must be an alternating current.

In another embodiment, the LED lighting system comprises a constant AC current source, a current transformer electromagnetically coupled to the constant AC current source, a circuit loop electrically connected to the current transformer, and one or more light emitting diodes electrically connected in an anti-parallel configuration in the circuit loop. The electrical source is an alternating current. Each pair of the one or more light emitting diodes is separately connected in an anti-parallel configuration and is connected by electrical wire to a corresponding current transformer.

In yet another embodiment, the LED lighting system comprises a constant AC current source, a current transformer electromagnetically coupled to the constant AC current source, a full wave bridge rectifier electrically connected to the current transformer, a circuit loop electrically connected to the full wave bridge rectifier, and one or more light emitting diodes electrically connected in a series configuration in the circuit loop. Again, the electrical source is an alternating current. The one or more light emitting diodes are singly or plurally connected in a series configuration and are connected by electrical wire to a corresponding full wave bridge rectifier, which is in turn electrically connected to a corresponding current transformer.

In a further embodiment, the LED lighting system comprises a constant AC current source, a circuit loop including a voltage clamping circuit electrically connected to the constant AC current source, and one or more light emitting diodes electrically connected in the circuit loop. The circuit loop consists of electrical wire connecting the constant AC current source directly to the one or more light emitting diodes. A current transformer is preferably electrically connected to the circuit loop and electromagnetically coupled to the constant AC current source. The one or more light emitting diodes may be connected in an anti-parallel configuration in the circuit loop. A full wave bridge rectifier is preferably connected between the circuit loop and the current transformer, wherein the one or more light emitting diodes are connected in a series configuration in the circuit loop.

In a further preferred embodiment the LED light system is for use in a hostile/volatile atmosphere. Such system comprises a constant AC current source, wherein the constant AC current source is isolated from the hostile/volatile atmosphere in a airtight, watertight sealed container. A circuit loop is electrically connected to the constant electrical source. The circuit loop passes through the airtight, watertight sealed container in a sealed manner and the electrical connection between the circuit loop and the constant AC current source is thereby isolated from the hostile/volatile atmosphere. A current transformer is electromagnetically coupled to the circuit loop and one or more light emitting diodes are electrically connected to the current transformer. The one or more light emitting diodes and the electrical connections between the one or more light emitting diodes and the current transformer are encased in an airtight, watertight sealed housing such that the same are isolated from the hostile/volatile atmosphere.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 schematically illustrates a prior art LED lighting fixture circuit;

FIG. 2 schematically illustrates a prior art LED lighting fixture buck circuit;

FIG. 3 schematically illustrates a prior art LED lighting fixture boost circuit;

FIG. 4 schematically illustrates a preferred embodiment of the inventive LED lighting system;

FIG. 5 schematically illustrates another preferred embodiment of the inventive LED lighting system including a current transformer;

FIG. 6 schematically illustrates the preferred embodiment of the inventive LED lighting system of FIG. 5 including a plurality of LEDs;

FIG. 7 schematically illustrates another preferred embodiment of the inventive LED lighting system including a current transformer and a full wave bridge rectifier;

FIG. 8 schematically illustrates the preferred embodiment of the inventive LED lighting system of FIG. 7 including a plurality of LEDs;

FIG. 9 schematically illustrates another preferred embodiment of the inventive LED lighting system including a plurality of lighting systems as depicted in FIG. 5 arranged around a circuit loop;

FIG. 10 schematically illustrates the preferred embodiment of the inventive LED lighting system of FIG. 9 wherein the electrical source is derived from a multi-tap transformer;

FIG. 11 schematically illustrates the preferred embodiment of the inventive LED lighting system of FIG. 7 including a plurality of LEDs and a voltage clamping circuit; and

FIG. 12 schematically illustrates the preferred embodiment of the inventive LED lighting system of FIG. 10, wherein the electrical connections are sealed in protective housings.

### DETAILED DESCRIPTION OF THE PREFERRED EMBODIMENTS

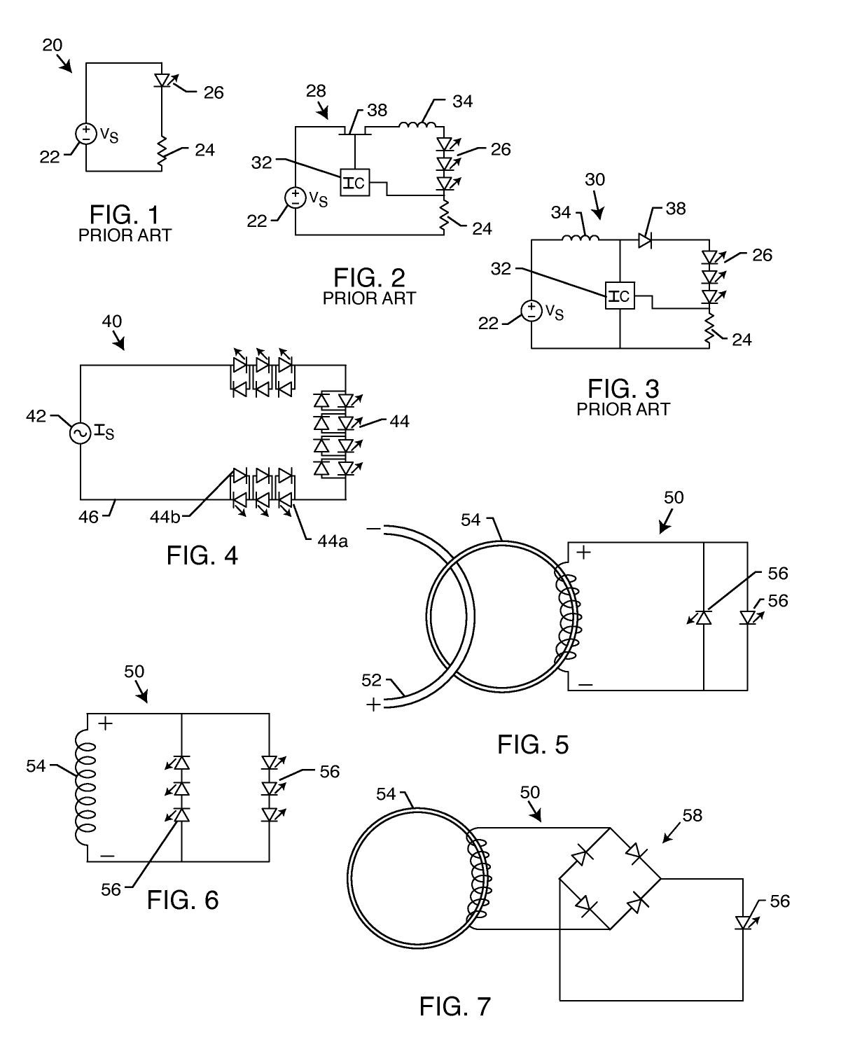

With reference to FIGS. 4-11, the LED lighting system of the present invention is generally referred to by reference numerals 40, 50 and 60. The solution to the problem of eliminating circuit elements from an LED fixture is to drive the LED fixtures from a constant AC current source. In the claimed invention, each LED lighting system 40, 50, 60 is comprised of a constant AC current electrical source 42 and one or more LEDs 44, electrically connected by a circuit loop 46.

FIG. 4 illustrates the basic preferred embodiment of the LED lighting system 40 of the present invention. In this system 40, a constant AC current source 42 provides the necessary constant current to power the LEDs 44 through the circuit loop 46. Where the voltage of the constant AC current source 42 is equal to the voltage drop of the LEDs 44 no resistor is needed. In the illustrated system 40, ten LED pairs 44 are depicted with each LED pair 44 having a voltage drop of 3-4 volts. In some of the figures, as in FIG. 4, the LEDs 44 are depicted in pairs in an anti-parallel configuration. This is done when using alternating current to power an LED. The LED pairs 44, include an LED 44a and a protective rectifying diode 44b connected in an anti-parallel configuration with the LED 44a to prevent reverse breakdown in every other half-cycle of an alternating current wave, as shown in FIG. 4. Alternatively, the LED pairs 44 can include two LEDs 44a connected in an anti-parallel configuration as shown in FIGS. 5, 6, 9, 10 and 12.

As illustrated in FIG. 4, a commercially available constant current AC power source at 60 Hz, for example, can be used. The fixtures can have either back-to-back (anti-parallel) LEDs or a full wave rectifier (described below). A problem arises because, since each LED drops about 3-4V, ten LED lamps in a loop would require about 35-40V to drive the current around the loop, such as around a garden/landscape area. This is very near the maximum voltage allowed for outdoor landscape lighting systems. Further, since LED lamps only need 0.35 A to drive them, the wire needed would likely be very fine to minimize the voltage drop in the line and thus easily broken, particularly in a landscape setting. Another consideration is that ten LED lamps will only supply about 650 lumens, the equivalent of a 14 W CFL light bulb. Thus, it is preferable to include more than ten LED lamps in a particular circuit.

FIGS. 5, 6, 7 and 8 illustrate another preferred embodiment of the LED lighting system 50. FIGS. 5 and 6 illustrate the system 50 with a circuit loop 52 providing a source of constant current electricity. The circuit loop 52 is coupled to a current transformer 54 having a ratio of preferably between 20:1 and 200:1. However, the ratio of the current transformer 54 may be as low as 10:1 and as high as 1000:1. The current transformer 54 is then connected to LED pair(s) 56 connected in an anti-parallel configuration as discussed above. FIG. 5 illustrates a single LED pair 56. FIG. 6 illustrates three LED pairs 56. The number of LED pairs 56 that can be included is limited by the total voltage of the circuit and the combined voltage drop of the LED pairs 56. Where a current transformer is used, the electrical source must be an alternating current.

Such current transformers 54 and the manners of using the same are known in the relevant art. Current transformers 54 come in multiple forms, including a donut or circular core. Another form of the current transformer 54 includes a “cut” or “C” core. When using a donut core current transformer 54, the wire circuit loop 52 must be run through the core prior to being connected at its ends to the electricity source. When using a “cut” core current transformer 54, the current transformer can be “clamped” onto the circuit loop 52 at any time before or after the ends are connected to the electricity source. The advantage of a “cut” core current transformer 54 is apparent in that a given light in any LED lighting system 50 can be removed and/or replaced on a circuit loop 52 without having to disconnected the circuit loop 52 from the electricity source. Any reference to a current transformer in this specification is intended to include either a donut core or a “cut” core current transformer.

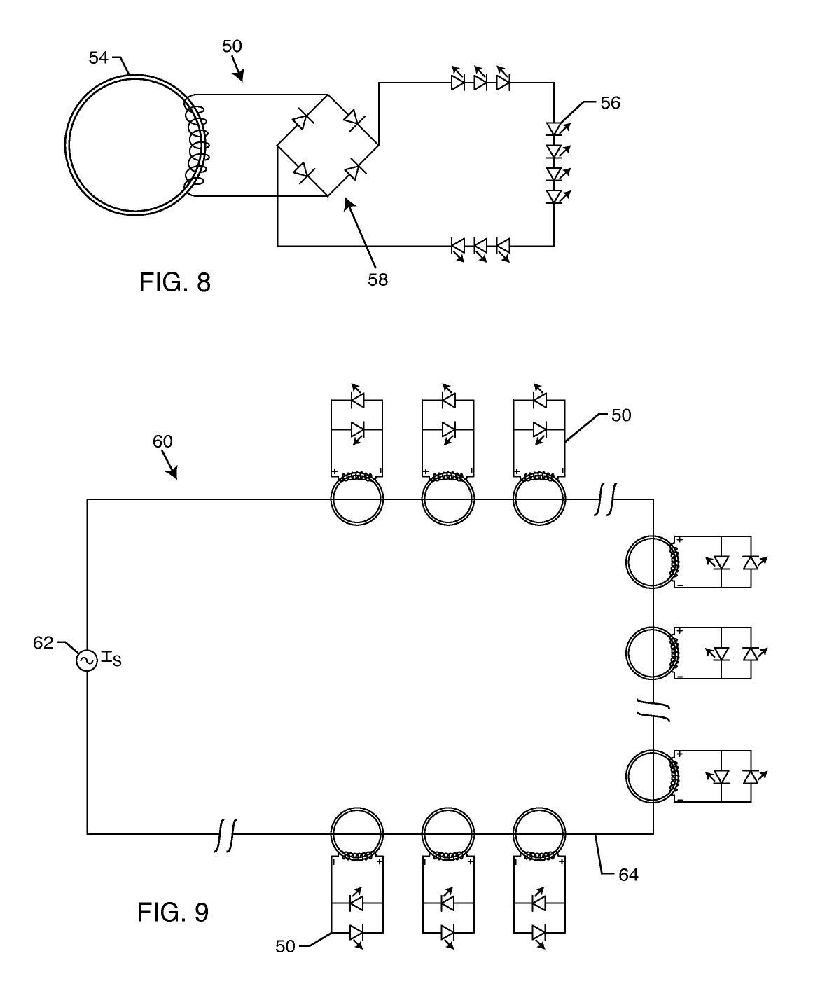

FIGS. 7 and 8 illustrate the system 50 including a full wave bridge rectifier 58. The inclusion of the full wave bridge rectifier 58 eliminates the need to have LED pairs connected in anti-parallel configuration. Since the rectifier 58 converts alternating current to direct current, it is no longer necessary to have the LED pairs connected in anti-parallel configuration to prevent reverse breakdown in every other half-cycle of the alternating current wave. Thus, the LEDs 56 can be presented singly, as shown in FIG. 7, or with a plurality in series, as shown in FIG. 8.

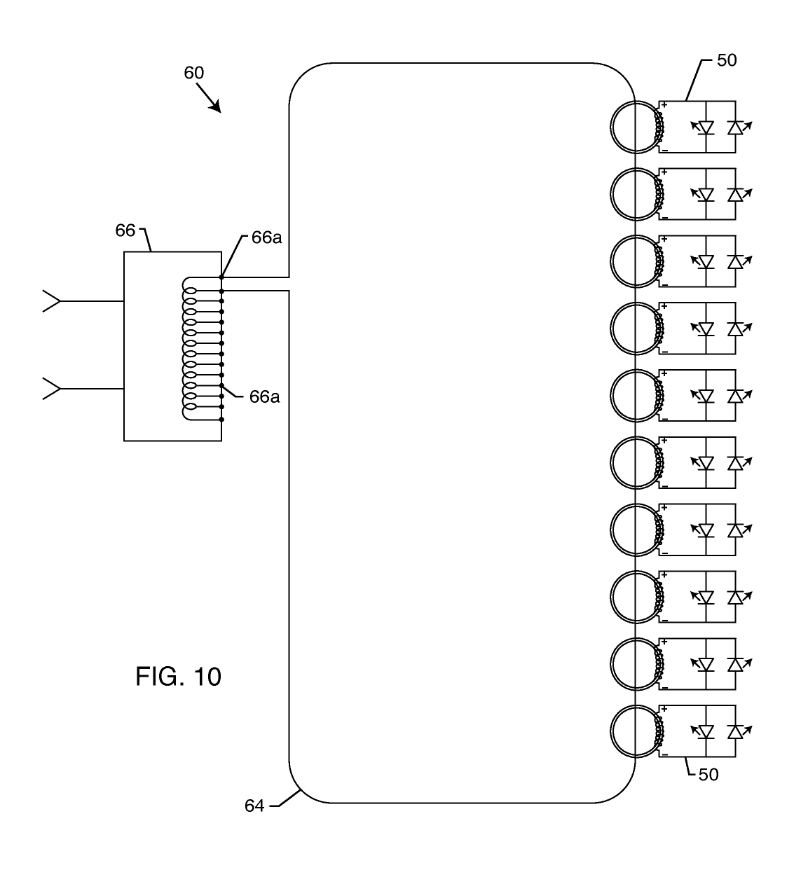

The current transformer 54 takes the supply current in the circuit loop 52 and steps it down to a reduced current accurately proportional to the supply current. With a supply current of 35 A, a current transformer 54 with a 100:1 ratio would produce a stepped down current of 350 mA. Typical LEDs require 350 mA at 4V. The primary voltage drop of this system would then be 0.04V (4V±100) or 40 mV. In a system driving three hundred LED lamps in a system 50 running a loop current of 35 A, the required voltage would be 300×0.04V or approximately 12V. Landscape lighting systems typically are operated at low voltages such as 12V. The current and the current transformer ratio can be adjusted to accommodate the characteristics of a particular system. The embodiments of the LED lighting system 50 including the current transformer 54 are configured to eliminate the need for mechanical connections, i.e., wire connections, at the light fixture once the fixture is built. As described below with FIGS. 9 and 10, the wire for the circuit loop is just passed through the core of the current transformer 54 without the need for making any wire connections.

A limitation to this configuration is that a current transformer 54 with a 0.5″×0.5″ cross-sectional area will saturate at about 5V output so that each current transformer 54 will only drive one LED or LED pair 56. One solution to overcome this limitation is to increase the cross sectional area of the current transformer 54. A current transformer 54 with a cross-sectional area of 1″×1″ would not saturate until about 20V output. Twenty volts of output would drive about five LEDs connected in series. This solution is expensive and would make the current transformer very bulky, particularly for LED light fixtures that are intended to be more compact.

Another solution to this limitation is to drive the current loop using a higher frequency of electricity. Typically, electrical current in the United States and most industrialized countries is provided at fifty or sixty hertz. A current transformer 54 used with electricity at a frequency higher than sixty hertz—say six hundred hertz—can achieve similar step down performance with a reduced size core. The frequency of the electricity can be as high as 6,000 hertz, but may be limited by potential FCC regulations. Higher electrical frequencies could result in inductance in the circuit loop limiting the current in the loop.

A current transformer with a cross-sectional area of 0.5″×0.5″ run at 600 Hz will not become saturated until about 50V—ten times the limit discussed above. Such a current transformer 54 at six hundred hertz can drive ten or more LEDs in each fixture. Mathematically, one hundred LED fixtures with a supply current of 35 A and each LED fixture with current transformer as described would each have a voltage drop of about 0.4V (40V÷100). If each LED fixture drops 0.4V, then the one hundred fixtures would need a 35 A supply at 40V. This is within the limits for a landscape lighting system.

FIGS. 9 and 10 illustrate yet another preferred embodiment of the LED lighting system 60. This system 60 includes a constant AC current source 62 connected to a circuit loop 64. A plurality of LED lighting systems 50 as described and depicted in FIG. 5 are arranged around this circuit loop 64. The LED lighting systems 50 can also be as described and depicted in FIG. 6, 7 or 8. The wire of the circuit loop 64 passes through the current transformers 54 on each of the systems 50. The configuration of this system 60 is consistent with the inclusion of one hundred LED fixtures discussed in the previous paragraph. The circuit loop 64 is lined to indicate that it could be much larger to accommodate a greater number of LED lighting systems 50, such as one hundred or more.

FIG. 10 illustrates a variation on the LED lighting system 60 depicted in FIG. 9. In this variation, the constant AC current source 62 includes a multi-tap transformer 66 which supplies electricity at a constant current. The multi-tap transformer 66 provides multiple connections 66a for electrical supplies at different voltages. Each of the multiple connections 66a are configured to supply a constant current supply of electricity. Depending upon the number of LED lighting systems 50 and the calculated voltage drop on each, the circuit loop 64 can be connected to taps ranging from 12V to 30V or other voltages as may be provided by the multi-tap transformer 66.

In a particularly preferred embodiment, an LED lighting system 50, 60 includes a current transformer 54 having a ratio of 70:1 and a core with a 2.5″ outer diameter, a 0.5″ hole, and a 0.626″ thickness. Such an LED lighting system 50, 60 with an electrical source of at six hundred hertz providing 20 A at 30V could accommodate about fifty LED fixtures 50.

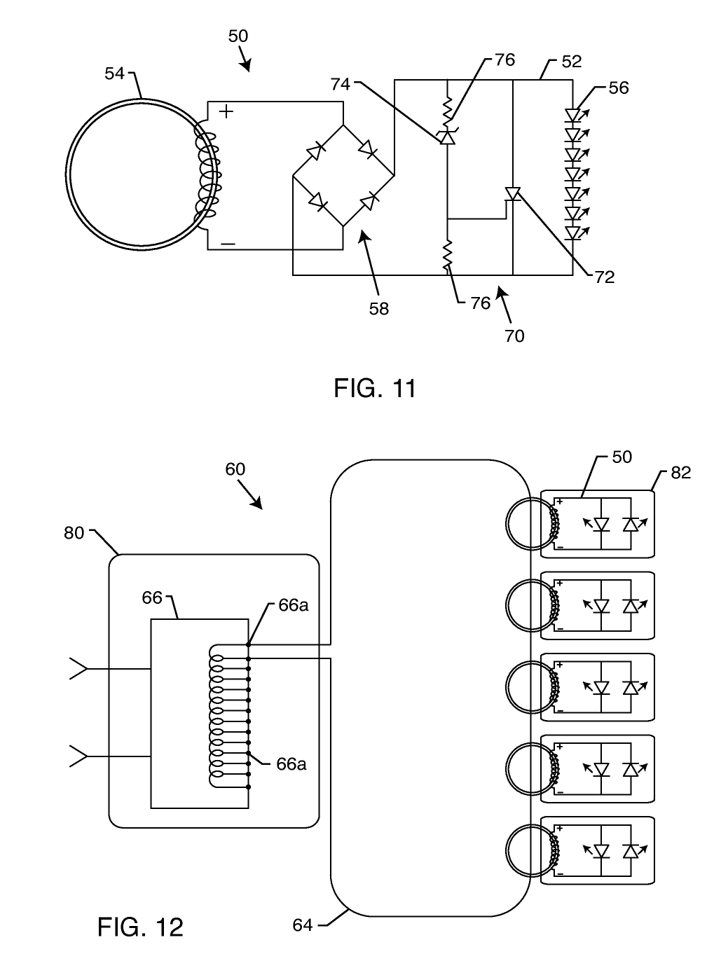

FIG. 11 illustrates a variation on the LED lighting system 50 depicted in FIG. 8. In this variation, the circuit loop 52 includes a voltage clamping circuit 70 configured to prevent increasing, run-away voltage in the case of an open circuit in the system 50. The voltage clamping circuit 70 described herein includes a silicon controlled rectifier 72, a zener diode 74, and two resistors 76 connected in a manner known in the art. In the illustrated configuration, the zener diode 74 should be configured for about 36V to sufficiently protect the circuit assuming that each of the seven LEDs 56 have about a 4V voltage drop for a total circuit voltage of 28V. Stated another way, the voltage of the zener diode 74 should be slightly greater than the total voltage necessary to run the circuit. Other configurations of the voltage clamping circuit 70 are known by those skilled in the art and can be employed in the inventive systems 40, 50, 60.

The LED lighting system of the present invention finds particular application in hostile or volatile environments where exposed electrical connections present a weakness or hazard. Such environments may include marine air or other moisture-rich air environments as on the rigging, hull or structure of a boat or in a water park. In such environments, the moisture in the air can corrode exposed metal as found in electrical connections, such as those connecting the wires supplying electricity to a light fixture. Another type of volatile environment may include a mine or a refinery that may be filled with explosive liquids/vapors or other volatile compounds. One wants to avoid exposing such explosive or volatile liquids/vapors to electrical connections, such as those involved with typical lighting systems that can cause the explosive or volatile liquids/vapors to combust.

The lighting system of the present invention lends itself to use in such hostile or volatile environments by the elimination of such electrical connections. Stated another way, the above-described invention provides a connectionless, electro-magnetically coupled lighting system which facilitates the isolation or shielding of exposed electrical connections from hostile or volatile environments. The inventive lighting system can illuminate the rigging of a boat with reduced concerns about corrosion or risk of shock. Similarly, the inventive lighting system may be completely submerged under water as on the hull of a boat or decoration on a harbor/pier. The inventive lighting system can also be exposed to volatile liquids or gasses with minimal concern about combustion or explosion.

The circuit loop of any of the above-described embodiments is merely a length of insulated electrical wire. The initiation and termination of the circuit loop occurs at a transformer or other source of electricity. The electrical connection of the initiation and termination of the circuit loop to the electrical source can be isolated from the hostile or volatile environment by being placed in a remote location or otherwise sealed off from the hostile or volatile environment i.e., as in an airtight, watertight container or housing. The remainder of the circuit loop comprises uninterrupted insulated wire without intervening electrical connections or other components that would expose the wire or electricity therein to the hostile or volatile environment.

Similarly, the light fixtures can be encased in an airtight, watertight sealed container or housing such that the hostile or volatile environment cannot reach the interior thereof. The sealed container or housing need only be configured such that the current transformer associated with the light fixture is accessible so that the insulated wire of the circuit loop can be passed through the opening thereof. With the circuit loop passed through the current transformer, the light fixture is electromagnetically coupled to the circuit loop such that the electricity from the circuit loop is transferred to the light fixture through the electromagnetic field coupled to the current transformer. In this way there are no exposed electrical connections to be corroded or otherwise disabled by a hostile environment, i.e., saltwater air, or to ignite a volatile environment, i.e., gasoline vapors as in a petroleum facility.

FIG. 12 illustrates a variation on the inventive lighting system of the present invention. Although FIG. 12 illustrates this variation in connection with the LED lighting system 60 depicted in FIG. 10, such variation is applicable to any of the above-described embodiments. In this variation, the system 60 includes a multi-tap transformer 66 that supplies electricity at a constant current. This transformer 66 is connected to a circuit loop 64 which is passed through the current transformer 54 on each of a plurality of LED lighting systems 50. The variation in this embodiment comprises an airtight, watertight sealed container or housing 80 that contains the multi-tap transformer 66 and the electrical connections thereon 66a. This sealed container or housing 80 serves to isolate the electrical connections 66a from the atmosphere in which the circuit loop 64 is disposed. In this way, the electrical connections 66a can be safely isolated from a hostile or volatile environment as discussed above so as to minimize the risk of corrosion of the electrical connections 66a or explosion of the volatile atmosphere. The wires of the circuit loop 64 pass through the sealed container or housing 80 in such a way that the sealed container or housing 80 remains airtight and/or watertight.

Further, the LED lighting systems 50 are encased in an airtight, watertight sealed container or housing 82. This sealed container or housing 82 is configured in such a way that the current transformer 54 is accessible for the circuit loop 64 to be passed therethrough. The sealed container or housing 82 may comprise a typical light fixture housing that is sealed against the intrusion of air and water. Alternatively, the sealed container or housing 82 may comprise a plastic coating provided that such coating is immune to corrosion. Because of the connectionless electromagnetic coupling between the circuit loop 64 and the current transformer 54, there are no exposed electrical connections outside of the sealed container or housing 82. In fact, the sealed container or housing 82 may encase the current transformer 54 provided that there is an opening therethrough to accept the circuit loop 64.

This embodiment of the inventive lighting system finds application in many areas other than landscape lighting or in-house lighting. For example, cruise ships have hundreds and thousands of lamps disposed all over the ship and in the rigging. Using this described embodiment, the complete lighting system would be protected against corrosion from the sea air to which they are constantly exposed. Further, the LED lighting systems 50 have a much greater life span than typical incandescent lights and the configuration of the system 60 eliminates the possibility of a series of LED lighting systems 50 going dark if a single system 50 fails.

In addition, the inventive lighting system 60 can also find use on large trucks and other vehicles having a large number of lights. Presently, each lamp has to be connected directly to the electrical supply of the vehicle. A single loose connection can cause one or more lamps to go out and there are hundreds of mechanical/electrical connections that can fail. The LED lighting system 60 of the present invention minimizes the number of electrical connections 66a that can fail, as a multitude of LED lighting systems 50 only require a single wire to run through the current transformers 54 on each system. Again, the long life of the LED lighting systems 50 is advantageous, as well as, the immunity to shock and vibration that such LED lighting systems 50 possess.

Although several embodiments of the invention have been described in detail for purposes of illustration, various modifications of each may be made without departing from the spirit and scope of the invention. Accordingly, the invention is not to be limited, except as by the appended claims.

What is claimed is:

1. An LED lighting system, comprising:
a constant AC current source;
a circuit loop electrically connected to the constant AC current source; and
one or more light emitting diodes electrically connected in the circuit loop.

2. The LED lighting system of claim 1, wherein the one or more light emitting diodes are connected in a series configuration or in an anti-parallel configuration.

3. The LED lighting system of claim 1, wherein the circuit loop consists of electrical wire connecting the constant AC current source directly to the one or more light emitting diodes.

4. The LED lighting system of claim 1, wherein the circuit loop consists of electrical wire connecting the one or more light emitting diodes to a current transformer, which is electromagnetically coupled to the constant AC current source.

5. The LED lighting system of claim 4, wherein the current transformer has a ratio of between 20:1 and 200:1.

6. The LED lighting system of claim 4, wherein the constant AC current source provides electricity having a frequency of between 50 hertz and 6,000 hertz.

7. The LED lighting system of claim 6, wherein the constant AC current source provides electricity having a frequency of about 600 hertz.

8. The LED lighting system of claim 1, wherein the circuit loop consists of electrical wire connecting the one or more light emitting diodes to a full wave bridge rectifier electrically connected to a current transformer and the current transformer is electromagnetically coupled to the constant AC current source.

9. An LED lighting system, comprising:
a constant AC current source;
a current transformer electrically coupled to the constant AC current source;
a circuit loop electrically connected to the current transformer; and
one or more light emitting diodes electrically connected in an anti-parallel configuration in the circuit loop.

10. The LED lighting system of claim 9, wherein each pair of the one or more light emitting diodes is separately connected in an anti-parallel configuration and is connected by electrical wire to a corresponding current transformer.

11. The LED lighting system of claim 9, wherein the one or more current transformers have a ratio of between 20:1 and 200:1.

12. The LED lighting system of claim 9, wherein the constant AC current source provides electricity having a frequency of between 50 hertz and 6,000 hertz.

13. The LED lighting system of claim 12, wherein the constant AC current source provides electricity having a frequency of about 600 hertz.

14. An LED lighting system, comprising:
a constant AC current source;
a current transformer electrically coupled to the constant AC current source;
a full wave bridge rectifier electrically connected to the current transformer;
a circuit loop electrically connected to the full wave bridge rectifier; and
one or more light emitting diodes electrically connected in a series configuration in the circuit loop.

15. The LED lighting system of claim 14, wherein the one or more light emitting diodes are singly or plurally connected in a series configuration and are connected by electrical wire to a corresponding full wave bridge rectifier, which is in turn electrically connected to a corresponding current transformer.

16. The LED lighting system of claim 14, wherein the one or more current transformers have a ratio of between 20:1 and 200:1.

17. The LED lighting system of claim 14, wherein the constant AC current source provides electricity having a frequency of between 60 hertz and 6,000 hertz.

18. The LED lighting system of claim 17, wherein the constant AC current source provides electricity having a frequency of about 600 hertz.

19. An LED lighting system, comprising:
a constant AC current source;
a circuit loop, including a voltage clamping circuit, electromagnetically coupled to the constant AC current source; and
one or more light emitting diodes electrically connected in the circuit loop.

20. The LED lighting system of claim 19, wherein the circuit loop consists of electrical wire connecting the constant AC current source directly to the one or more light emitting diodes.

21. The LED lighting system of claim 19, further comprising a current transformer electrically connected to the circuit loop and electromagnetically coupled to the constant AC current source.

22. The LED lighting system of claim 21, wherein the one or more light emitting diodes are connected in an anti-parallel configuration in the circuit loop.

23. The LED lighting system of claim 21, further comprising a full wave bridge rectifier connected between the circuit loop and the current transformer, wherein the one or more light emitting diodes are connected in a series configuration in the circuit loop.

24. An LED lighting system for use in a hostile/volatile atmosphere, comprising:
a constant AC current source, wherein the constant AC current source is isolated from the hostile/volatile atmosphere by an airtight, watertight sealed container;
a circuit loop electrically connected to the constant AC current source, wherein the circuit loop passes through the airtight, watertight sealed container in a sealed manner and the electrical connection between the circuit loop and the constant AC current source is isolated from the hostile/volatile atmosphere;
a current transformer electromagnetically coupled to the circuit loop;
one or more light-emitting diodes electrically connected to the current transformer, wherein the one or more light-emitting diodes and the electrical connections between the one or more light emitting diodes and the current transformer are encased in an airtight, watertight sealed housing such that the same are isolated from the hostile/volatile atmosphere.

25. The LED lighting system of claim 24, wherein the one or more current transformers have a ratio of between 20:1 and 200:1.

26. The LED lighting system of claim 24, wherein the constant AC current source provides electricity having a frequency of between 60 hertz and 6,000 hertz.

27. The LED lighting system of claim 26, wherein the constant AC current source provides electricity having a frequency of about 600 hertz.
